(19) United States
(12) Patent Application Publication
(10) Pub. No.: US 2009/0174533 A1
(43) Pub. Date: Jul. 9, 2009

(54) Instrumentation Assembly For A Vehicle

(76) Inventors: Upton Beall Bowden, Canton, MI (US); Henry Lee Pope, Redford, MI (US); Eric Marshall Knight, Dearborn, MI (US); T. C. Wingrove, Canton, MI (US)

Correspondence Address: DICKINSON WRIGHT PLLC, 1875 Eye Street, NW, Suite 1200, WASHINGTON, DC, 20006, US

(21) Appl. No.: 11/969,891

(22) Filed: Jan. 5, 2008

(51) Int. Cl. B60Q 1/00

(52) U.S. Cl. 340/425.5

(57) ABSTRACT

An instrumentation assembly for installation in the dashboard of a vehicle is disclosed herein. The instrumentation assembly includes an electronic controller, an enclosure, a viewable gauge, a viewable display, and a proximity-sensing switch. The controller has a memory for storing information. The enclosure has a designated front section and a designated rear section, wherein the front section includes substantially transparent material so as to define a window. Both the gauge and the display are electrically connected to the controller and mounted within the enclosure so as to substantially face the window. The switch is electrically connected to the controller and operable to sense the proximal presence of a mass, such as a human finger. In this configuration, the display is operable to exhibit the memory's information for viewing, and the switch is activatable by a human finger to selectively control the exhibition of the information on the display.

### FIELD OF THE INVENTION

The present invention generally relates to automotive vehicles. The present invention more particularly relates to instrument panels and gauge clusters onboard such vehicles.

### BACKGROUND OF THE INVENTION

Observable gauge clusters that are located within the instrument panels or dashboards of automotive vehicles typically support a range of various functions. Some of these functions may include, for example, providing vehicle odometer (i.e., mileage) information and also providing vehicle trip mileage information. Typically, a vehicle driver's use of these functions is controlled via a single pushbutton (PB) switch that protrudes outward from an instrument panel's circuit board, out through a viewable appliqué, and ultimately out through a transparent lens (i.e., viewing window) of the instrument panel's gauge cluster. The hole that is defined through the gauge cluster's lens for accommodating the protruding pushbutton, however, often undesirably facilitates the introduction of dust and dirt into the instrument panel's enclosure. As a result, over time, dust and dirt can undesirably accumulate on the viewable appliqué in one or more of the panel's gauges and never be cleaned away. Consequently, the instrument panel and its gauges may begin to appear dirty and unattractive.

In addition to introducing dirt into an instrument panel's gauge cluster, such a pushbutton can also be awkward to reach and manipulate by a driver during vehicle operation, for the pushbutton is typically situated somewhat behind the steering wheel (i.e., handwheel) of a conventional vehicle. Furthermore, such a protruding pushbutton often adversely impacts instrument panel styling in an automotive vehicle.

In view of the above, there is a present need in the art for an automotive instrument panel assembly that eliminates such a protruding pushbutton from its gauge cluster while also retaining similar pushbutton control and functionality therein. In this way, therefore, mechanical penetration through an instrument panel's window or a gauge cluster's lens will largely be obviated.

### SUMMARY OF THE INVENTION

The present invention provides an instrumentation assembly for installation in the dashboard of a vehicle. In one embodiment, the instrumentation assembly includes an electronic controller, an enclosure, a viewable gauge, a viewable display, and a proximity-sensing switch. The controller has a memory for storing information. The enclosure has a designated front section and a designated rear section, wherein the front section includes substantially transparent material so as to define a window. Both the gauge and the display are electrically connected to the controller and mounted within the enclosure so as to substantially face the window. The switch is electrically connected to the controller and operable to sense the proximal presence of a mass, such as a human finger. In this configuration, the display is operable to exhibit the memory's information for viewing, and the switch is activatable by a human finger to selectively control the exhibition of the information on the display.

In general, the proximity-sensing switch itself may be situated in various locations about the instrumentation assembly's enclosure. For example, the switch may be situated within the enclosure and just behind the enclosure's thin window, or the switch may alternatively be situated just underneath a thin, outer skin layer of the dashboard. In this way, therefore, the switch can be activated without requiring mechanical penetration through the enclosure's window.

Furthermore, it is believed that various alternative embodiments of the present invention will become apparent to those skilled in the art when the detailed description of the best mode contemplated for practicing the invention, as set forth hereinbelow, is reviewed in conjunction with the appended claims and the accompanying drawing figures.

### BRIEF DESCRIPTION OF THE DRAWINGS

The present invention is described hereinbelow, by way of example, with reference to the following drawing figures.

FIG. 1 illustrates a frontal view of a conventional gauge cluster that is commonly present within the instrument panel of a modern automotive vehicle.

FIG. 2 illustrates a frontal view of an embodiment of an instrumentation assembly according to the present invention.

FIG. 3 illustrates a block diagram of an automotive vehicle system that includes the instrumentation assembly depicted in FIG. 2.

FIG. 4A illustrates a frontal view of an embodiment of an instrumentation module according to the present invention.

FIG. 4B illustrates a sectional side view of the instrumentation module depicted in FIG. 4A.

FIG. 5 illustrates a block diagram of an automotive vehicle system that includes the instrumentation module depicted in FIGS. 4A and 4B.

### LIST OF PARTS AND FEATURES

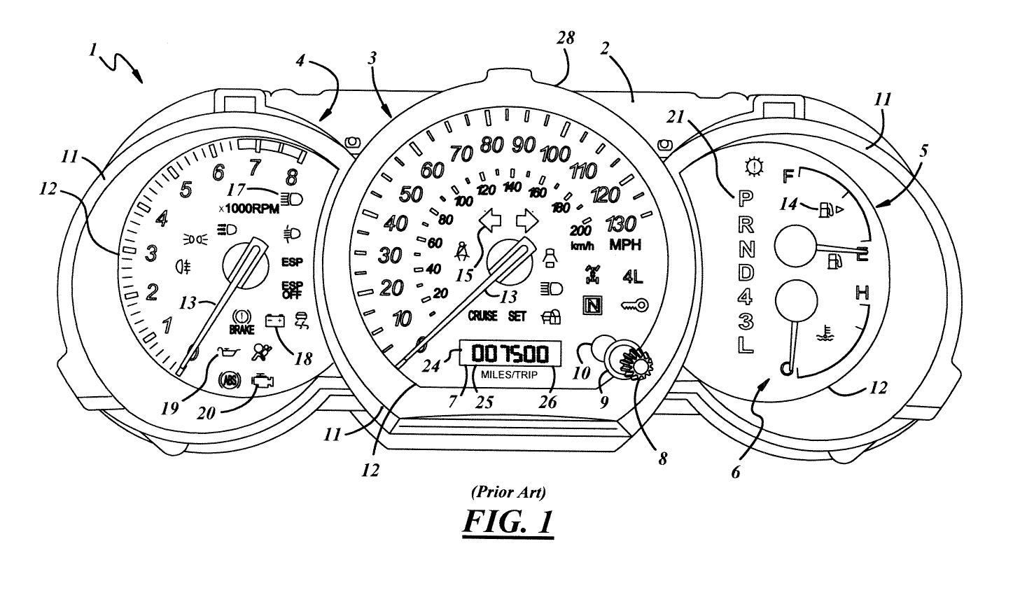

To facilitate an understanding of the present invention, a list of parts and features highlighted with alphanumeric designations in FIGS. 1 through 5 is set forth hereinbelow.
S1 proximity-sensing switch (situated behind window or lens)
S2 proximity-sensing switch (situated behind window or lens)
S3 proximity-sensing switch (situated behind window or lens)
S4 proximity-sensing switch (situated behind window or lens)
S5 proximity-sensing switch (situated behind window or lens)
S6 proximity-sensing switch (situated underneath outer skin of dashboard)
S7 proximity-sensing switch (situated underneath outer skin of dashboard)
S8 proximity-sensing switch (situated underneath outer skin of dashboard)
S9 proximity-sensing switch (situated underneath outer skin of dashboard)
S10 proximity-sensing switch (situated underneath outer skin of dashboard)
1 gauge cluster
2 instrument panel or dashboard (of automotive vehicle)
3 speedometer (an analog type gauge)
4 tachometer (an analog type gauge)
5 fuel-level gauge (an analog type gauge)
6 engine coolant temperature gauge (an analog type gauge)
7 odometer (shows total mileage and also trip mileage for a vehicle)
8 pushbutton switch (for use with odometer)
9 hole (defined through lens or window)
10 hole (defined through appliqué)
11 transparent lens or window (made of dielectric material such as glass or plastic)
12 viewable appliqué (including, for example, words, numbers, symbols, markings)
13 rotatable pointing needle (of an analog gauge)
14 low-fuel indicator (light)
15 left-turn indicator (light)
16 right-turn indicator (light)
17 high-beam indicator (light)
18 battery-charge indicator (light)
19 oil-pressure indicator (light)
20 check-engine indicator (light)
21 gear-position indicator (light(s))
22 mechanical pushbutton switch (PB1) (utile for setting minutes on a console clock)
23 mechanical pushbutton switch (PB2) (utile for setting hours on a console clock)
24 viewable digital display (for example, an LED, LCD, or VFD type display)
25 odometer total mileage information (for vehicle)
26 odometer trip mileage information (for vehicle)
27 climate condition information (for example, air temperature)
28 enclosure
29 front section (of enclosure)
30 instrumentation assembly
31 rear section (of enclosure)
32 electronic controller
33 memory (for storing information)
34 brow area (over a gauge cluster of an instrument panel)
35 electrical connector (on rear section of enclosure)
36 external wire harness
37 inner substrate (of dashboard)
38 dielectric outer skin (of dashboard)
39 light source (for example, an LED or a light projector)
40 vehicle speed sensor
41 engine speed sensor
42 fuel level sensor
43 coolant temperature sensor
44 air temperature sensor
45 battery charge sensor
46 air pressure sensor
47 other sensor(s)
48 data bus
49 vehicle battery
50 engine control module (ECM)
51 junction block (fuse box)
52 other indicator(s)
53 instrumentation module
54 audio system (including audio processor and power amplifier)
55 left speaker
56 right speaker
57 outer periphery (of enclosure)
58 volume control information
59 AM/FM radio tuner
60 external AM/FM radio antenna (onboard vehicle)
61 radio station tuning control information
62 external compact disc (CD) player/changer (onboard vehicle)
63 external phone system (onboard vehicle)
64 external climate control system (onboard vehicle)
65 external navigation system (onboard vehicle)
66 integrated circuit (IC) (of a proximity-sensing switch)
67 printed circuit board (PCB) (associated with audio system and speakers)
68 printed circuit board (PCB) (associated with controller, gauge, and display)
69 electric motor (for rotating needle of gauge)
70 hollow (of enclosure)
71 light rays (emanating from light source)
72 electrical lead line (between controller and IC of proximity-sensing switch)
73 proximity-sensing zone, actuation zone, or touch zone (of switch)
74 outer surface (of window)
75 inner surface (of window)
76 automotive vehicle system (with instrumentation assembly)
77 automotive vehicle system (with instrumentation module)

### DETAILED DESCRIPTION OF THE INVENTION

FIG. 1 illustrates a frontal view of a conventional gauge cluster 1 that is mounted in an instrument panel 2 of a modern automotive vehicle. As shown, the gauge cluster 1 includes a speedometer 3, a tachometer 4, a fuel-level gauge 5, and an engine coolant temperature gauge 6. The speedometer 3, in particular, includes an odometer 7 with a digital display 24. The digital display 24 exhibits either total mileage information 25 or trip mileage information 26 for the vehicle, as selectively controlled by a pushbutton 8. As illustrated in FIG. 1, the pushbutton 8 protrudes outward from the instrument panel 2, through a hole 10 defined through an appliqué 12, and ultimately out through a hole 9 defined through a transparent lens (or window) 11 of the speedometer 3. Such penetration through the lens 11, however, often undesirably facilitates the introduction of dust and dirt into the instrument panel's enclosure 28 via the lens hole 9. As a result, over time, dust and dirt can undesirably accumulate on the speedometer's viewable appliqué 12 and never be cleaned away. Consequently, the speedometer 3 and the overall instrument panel 2 may begin to appear dirty and unattractive.

To remedy such a problem, the present invention proposes an instrumentation assembly that eliminates such a protruding pushbutton from its gauge cluster while also retaining similar pushbutton control and functionality therein. In this way, therefore, mechanical penetration through a gauge cluster's lens will largely be obviated, thereby ensuring that the inside of the instrument panel's enclosure stays clean and attractive.

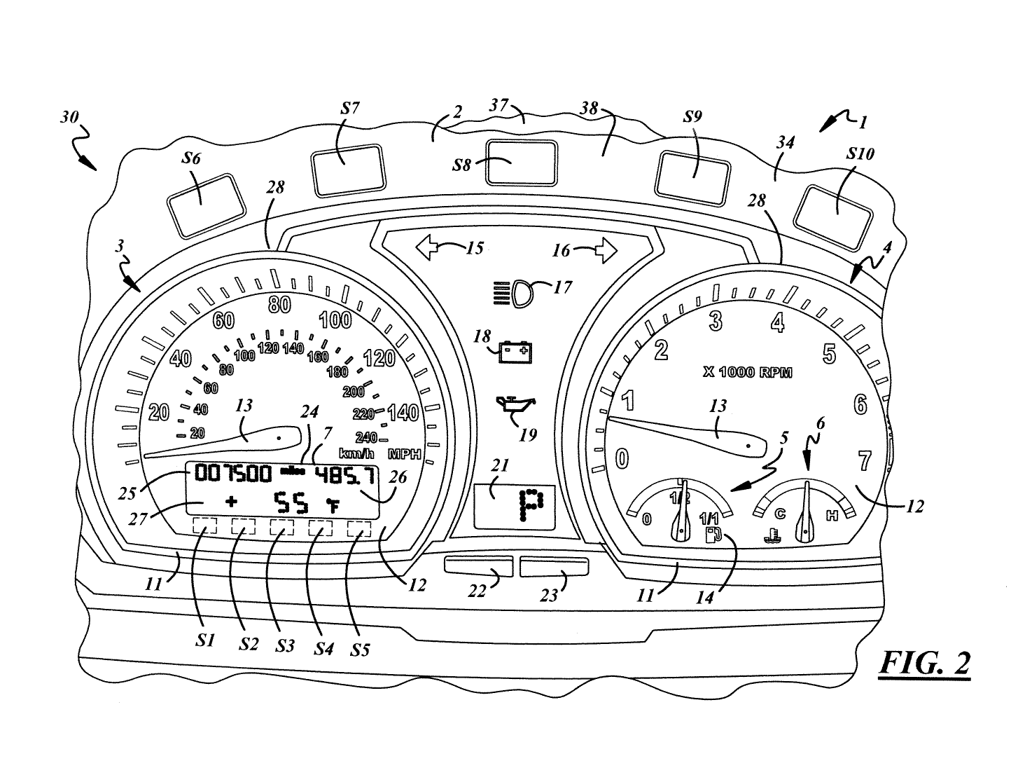

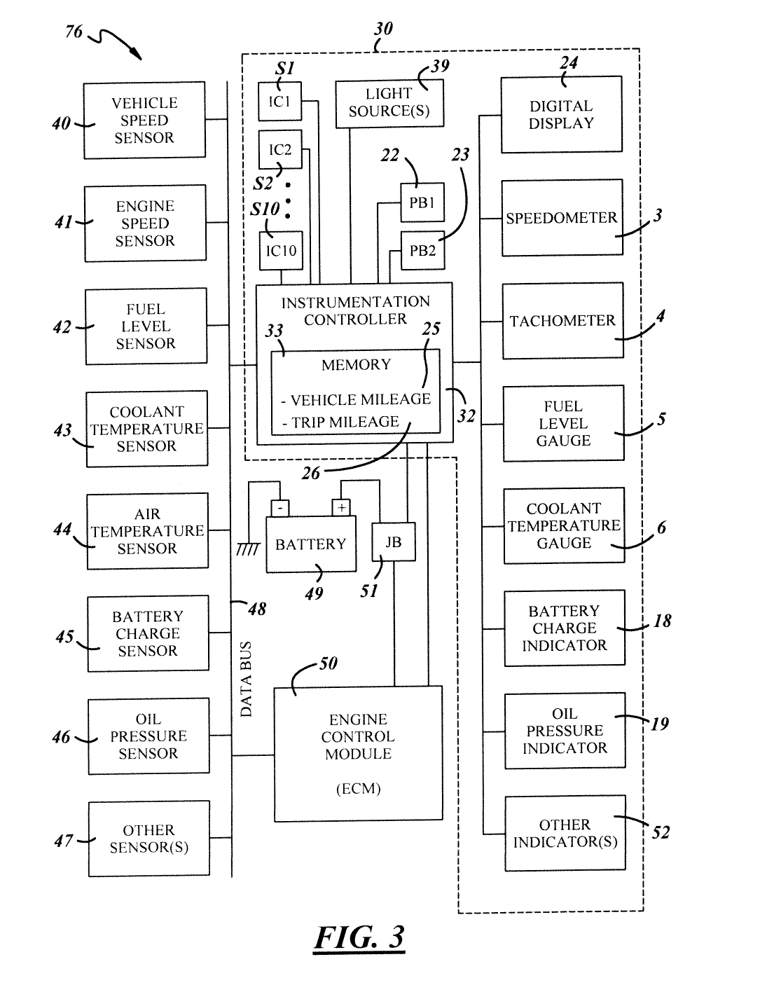

FIG. 2 illustrates a frontal view of one embodiment of an instrumentation assembly 30 according to the present invention. In addition thereto, FIG. 3 illustrates a block diagram of an automotive vehicle system 76 that includes the instrumentation assembly 30 depicted in FIG. 2. As shown in these figures, the instrumentation assembly 30 includes an electronic controller 32, an enclosure 28, at least one viewable gauge, a viewable display 24, and at least one proximity-sensing switch S. The controller 32 has a memory 33 for storing various types of information. The enclosure 28 has a designated front section and a designated rear section, wherein the front section includes substantially transparent material so as to define at least one window 11. Each gauge and the display 24 are electrically connected to the controller 32 and mounted within the enclosure 28 so as to substantially face the window(s) 11. Each switch S is electrically connected to the controller 32 and operable to sense the proximal presence of a mass, such as a human finger. In this configuration, the display 24 is operable to exhibit the memory's information or other information for viewing, and each switch S is activatable by a human finger to selectively control the exhibition of various types of information on the display 24. Furthermore, though the embodiment of the instrumentation assembly 30 shown in FIGS. 2 and 3 particularly includes ten proximity-sensing switches S1-S10, it is to be understood that an instrumentation assembly pursuant to the present invention may alternatively have fewer or more switches in other embodiments.

Moreover, in the embodiment shown in FIGS. 2 and 3, each of the proximity-sensing switches S1-S10 is a touch-sensor type switch such as, for example, a field-effect switch, an electric-field switch, a capacitive switch, an infrared switch, an acoustic switch, or an electromagnetic switch. In embodiments built to date, field-effect switches referred to as “TouchCells™,” which are manufactured by TouchSensor Technologies LLC of Wheaton, Ill., have been successfully incorporated in instrumentation assemblies pursuant to the present invention. During operation, the electrically charged electrodes of a TouchCell's integrated circuit (IC) can sense, and be activated by, the proximal encroachment or actual touch of an electrically conductive mass. Such an electrically conductive mass may include, for example, a human finger or a metallic stylus. Since actual touch of a TouchCell's electrodes is not necessary to activate a TouchCell, a TouchCell may therefore be activated by an encroaching conductive mass, even if the TouchCell and the mass are physically separated by an intervening dielectric structure, such as a thin layer of glass or plastic. Furthermore, though embodiments built to date have successfully incorporated such TouchCells, it is believed that other types of proximity-sensing switches produced by other manufacturers may alternatively be incorporated in instrumentation assemblies pursuant to the present invention as well.

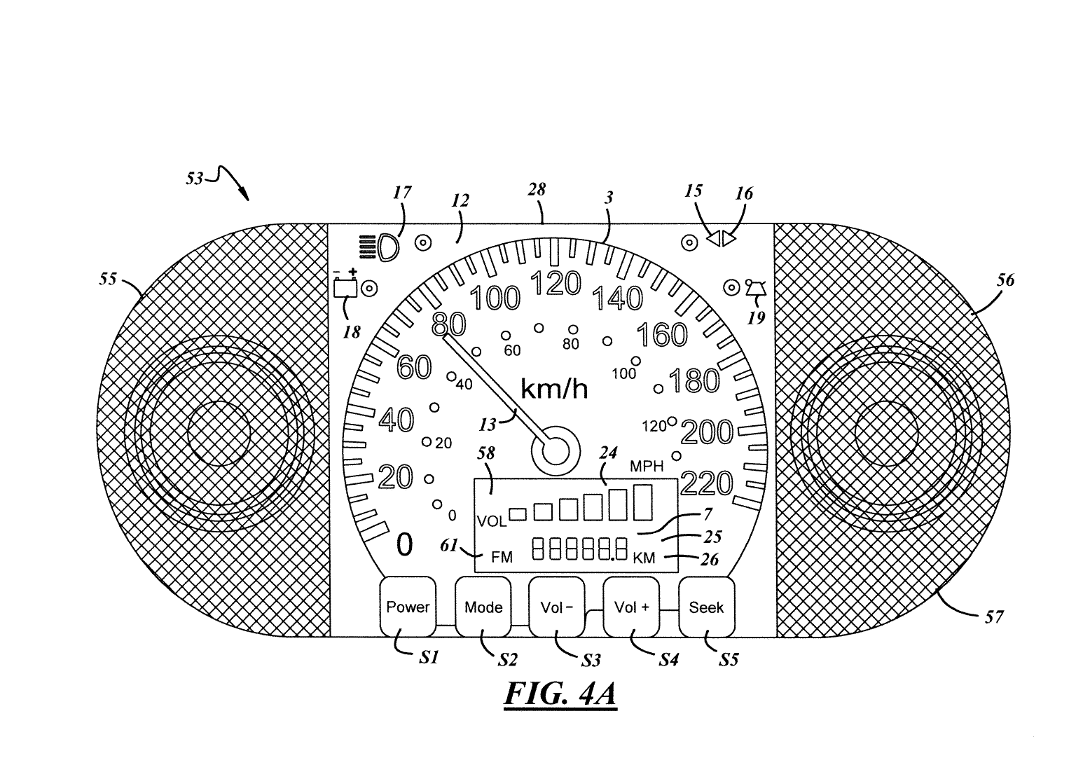

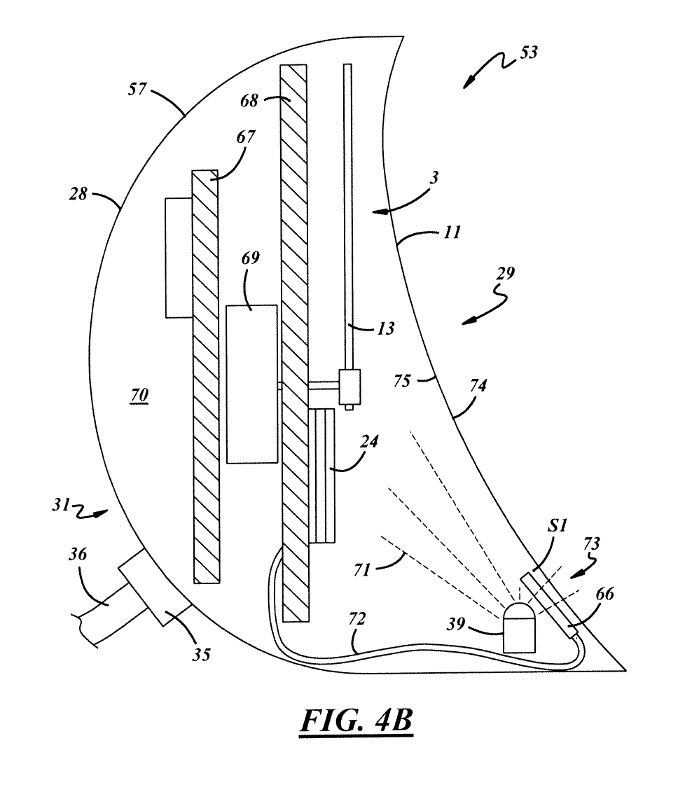

In general, a proximity-sensing switch may be situated in many various different locations in or about the enclosure of an instrumentation assembly pursuant to the present invention. In FIG. 2, the proximity-sensing switches S1-S5 are situated within the enclosure 28 of the speedometer 3, just behind the speedometer's window 11. Situated as such, each of the switches S1-S5 can be individually activated by a human fingertip that closely encroaches or touches a corresponding area on the outer surface 74 of the window 11. To assist a person in selecting and activating a desired switch, the outer surface 74 or inner surface 75 of the window 11 may be stenciled, painted, or back lit (see FIG. 4B) with switch or function-identifying words, markings, or icons. Also in FIG. 2, the proximity-sensing switches S6-S10 are alternatively situated just underneath the dielectric outer skin 38 of a brow area 34 on the dashboard 2. Situated as such, each of the switches S6-S10 can be individually activated by a human fingertip that closely encroaches or touches the outer surface of a corresponding skin area that covers a switch. To assist a person in selecting and activating a desired switch, the outer surface of the dashboard's skin 38 may be stenciled, painted, or stitched with switch or function-identifying words, markings, or icons. Furthermore, though the switches S1-S10 in FIG. 2 are largely situated in or about the enclosure 28 of the instrumentation assembly 30, such switches may alternatively be situated in other areas of a vehicle's cockpit. Such other areas may include, for example, a center stack console, a floor console, an overhead console, a door's trim, or even a steering wheel (handwheel).

Though the instrumentation assembly 30 is shown in FIGS. 2 and 3 as primarily including a speedometer 3, it is to be understood that an instrumentation assembly pursuant to the present invention may alternatively or additionally include other types of analog gauges as well. Such other analog gauges may include, for example, a tachometer 4, a fuel-level gauge 5, an engine coolant temperature gauge 6, and the like.

Furthermore, the viewable display 24 shown in FIG. 2 is generally a digital type display. As such, the display 24 may be, for example, a seven-segment display, a light-emitting diode (LED) display, a liquid-crystal display (LCD), a vacuum-fluorescent display (VFD), or similar others. The display 24 itself may exhibit many various different types of information. In general, the information exhibited by the display 24 is largely controlled by selective activation of the proximity-sensing switches S1-S10 or the mechanical pushbutton switches 22 and 23. Such information may include, for example, odometer total mileage information, odometer trip mileage information, air temperature information, clock time information, or still other information.

Moreover, in addition to the gauges, the display 24, and the proximity-sensing switches S1-S10, the instrumentation assembly 30 may further include one or more illuminable type indicators. Such indicators may include, for example, a left-turn indicator light 15, a right-turn indicator light 16, a high-beam indicator light 17, a battery-charge indicator light 18, an oil-pressure indicator light 19, a low-fuel indicator light 14, a check-engine indicator light 20, or others. In general, such illuminable type indicators may include light-emitting diodes (LEDs) or other conventional indicator light sources.

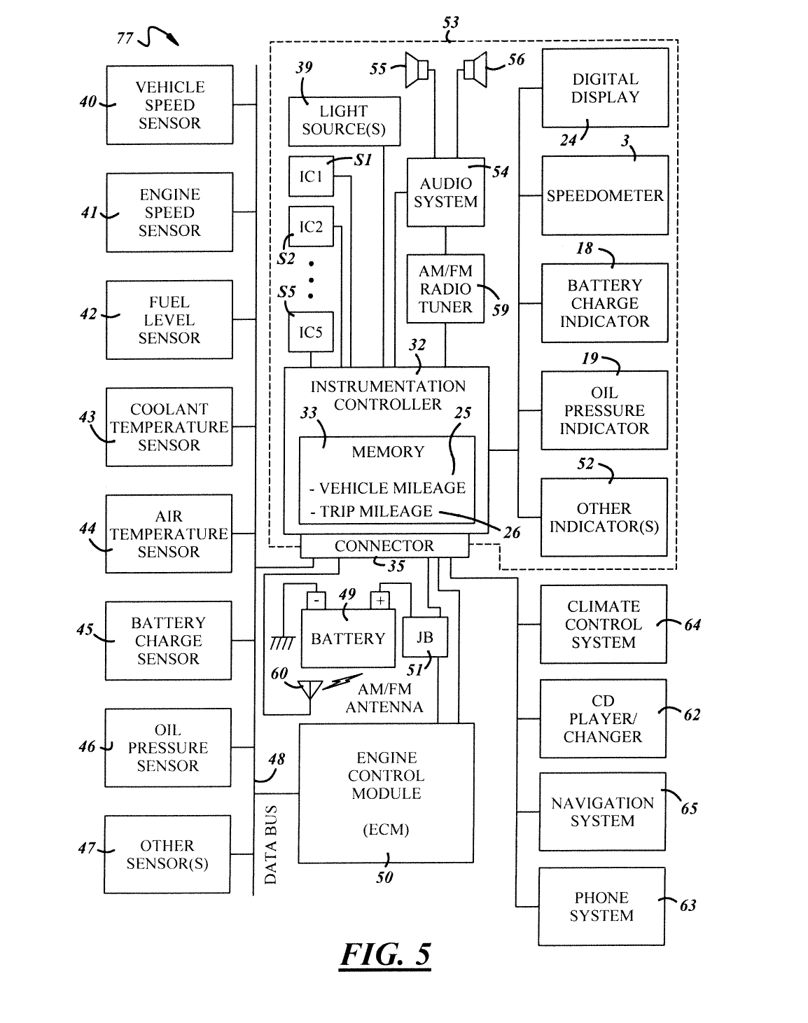

FIGS. 4A and 4B illustrate frontal and sectional side views of an embodiment of an instrumentation module 53 according to the present invention. In addition thereto, FIG. 5 illustrates a block diagram of an automotive vehicle system 77 that includes the instrumentation module 53 depicted in FIGS. 4A and 4B. As shown in these figures, the instrumentation module 53 is somewhat similar to the afore-described instrumentation assembly 30, except that the instrumentation module 53 is significantly more modular for purposes of in-vehicle installation and also includes an integrated audio system 54 with speakers 55 and 56.

As shown in FIGS. 4A and 4B, the overall enclosure 28 of the instrumentation module 53 has an outer periphery 57 that is largely rounded and a sectional profile that is substantially curvilinear. The instrumentation module 53 is shaped in this manner so as to facilitate easy installation of the module 53 into an automotive vehicle. As shown in FIGS. 4B and 5, the rear section 31 of the module's enclosure 28 has an electrical connector 35. In general, the connector 35 is electrically connected to the module's internal electronic controller 32 and is adapted for being electrically connected to an external wire harness 36. In this way, when the instrumentation module 53 is installed in a vehicle, the module's controller 32 is thereby electrically interfaced with the data bus 48, the engine control module (ECM) 50, and the battery 49 of the vehicle system 77 via the connector 35 and the harness 36. When the controller 32 is interfaced and connected in such a configuration, various sensor data, electrical control signals, and battery power can thus be electrically communicated to the controller 32, the display 24, the gauge(s), and the indicator(s) in the module 53.

Furthermore, as illustrated in FIGS. 4A and 5, the audio system 54 is electrically connected to the instrumentation module's controller 32. The left and right speakers 55 and 56, in turn, are electrically connected to the audio system 54 and are also mounted opposite each other at the periphery 57 of the module's enclosure 28. In this configuration, the proximity-sensing switches S1-S4 can be finger activated to selectively control operation of the audio system 54 with speakers 55 and 56. The switches S3 and S4, in particular, can be utilized to control and set the volume level of the audio system 54. To further help facilitate selective control of the audio system's volume, the module's display 24 is operable to exhibit volume control information 58.

As also illustrated in FIGS. 4A and 5, the instrumentation module 53 also includes an integrated AM/FM radio tuner 59. The radio tuner 59 is mounted within the module's enclosure 28 and is electrically connected to both the controller 32 and the audio system 54. The radio tuner 59 is adapted for being electrically connected, via the connector 35, to an external AM/FM radio antenna 60, which is mounted onboard the vehicle. In this configuration, all proximity-sensing switches S1-S5 can be selectively activated to control operation of the AM/FM radio tuner 59 together with the audio system 54. The switch S2 (i.e., the “Mode” switch), in particular, can be utilized in conjunction with the radio tuner 59 to select either an AM broadcast or an FM broadcast. After selecting a desired radio broadcast type with switch S2, the switch S5 (the “Seek” switch) can then be selectively held or quickly tapped so as to tune into a particular radio station broadcast along a broadcast frequency spectrum. To help in this selection process, the module's display 24 is operable to exhibit radio station tuning control information 61 for viewing. Once a radio station broadcast is ultimately selected with switch S5, the audio system 54 and speakers 55 and 56 operate together to audibly play the radio station broadcast, which is electrically communicated from the radio antenna 60 via the connector 35.

Moreover, as indicated in FIGS. 4A and 5, the module's controller 32 is adapted for being electrically connected, via connector 35, to an external compact disc (CD) player/changer 62, which is carried onboard the vehicle. When the controller 32 is connected as such, the switch S2 can be activated and utilized to obtain auxiliary (AUX) mode control over the CD player/changer 62. Once control is obtained, the switch S5 can then be utilized to seek and select particular CDs and songs for play on the audio system 54, and switches S3 and S4 can be utilized to set play volume. The module's display 24 is operable to exhibit CD player/changer control information for viewing.

Furthermore, as also indicated in FIGS. 4A and 5, the module's controller 32 is adapted for being electrically connected, via connector 35, to an external phone system 63, which is carried onboard the vehicle. When the controller 32 is connected as such, the switch S2 can be activated and utilized to obtain auxiliary (AUX) mode control over the phone system 63. Once such control is obtained, the switch S5 can then be utilized to seek and dial pre-programmed phone numbers that are stored in the phone system's memory or alternatively dial other phone numbers. During such operation of the phone system 63, the module's display 24 is able to exhibit phone number information and/or caller identification (ID) information for viewing. The audio system 54, in turn, is operable to selectively play each phone conversation over the speakers 55 and 56 to facilitate hands-free operation of the phone system 63.

As further indicated in FIGS. 4A and 5, the module's controller 32 is also adapted for being electrically connected, via connector 35, to an external climate control system 64, which is carried onboard the vehicle. When the controller 32 is connected as such, the switch S2 can be activated and utilized to obtain auxiliary (AUX) mode control over the climate control system 64. Once such control is obtained, the switches S3 and S4 can then be utilized to adjust blower fan (i.e., motor) speed of the climate control system 64. The switch S5, in turn, can be utilized to selectively activate the air-conditioning (AC) system, the heating system, or the defrost system of the climate control system 64. During such operation of the climate control system 64, the display 24 is operable to exhibit climate condition information 27 (for example, air temperature) and also climate control information for viewing.

Moreover, as also indicated in FIGS. 4A and 5, the module's controller 32 is also adapted for being electrically connected, via connector 35, to an external navigation system 65, which is mounted onboard the vehicle. When the controller 32 is connected as such, the switch S2 can be activated and utilized to obtain auxiliary (AUX) mode control over the navigation system 65. Once such control is obtained, the switches S3-S5 can then be utilized to operate the navigation system 65. During such operation of the navigation system 65, the module's display 24 is able to exhibit navigation information, such as vehicle heading or travel directions, as well as navigation system control information.

Furthermore, as shown in FIGS. 4B and 5, the instrumentation module 53 further includes at least one light source 39. The light source 39 is electrically connected to the instrumentation module's controller 32. The light source 39 is also mounted within the module's enclosure 28, generally between the display 24 and the switches S1-S5. Situated as such, the light source 39 generally serves to illuminate the front of both the speedometer 3 and the display 24. In addition, the light source 39 also serves as backlighting for the switches S1-S5, thereby making the switches S1-S5 easier to see and identify from outside the module's window 11. To further help a person see and identify the switches S1-S5, either the outer surface 74 or the inner surface 75 of the enclosure's window 11 may optionally be painted or stenciled with switch or function-identifying words, markings, or icons that are correspondingly situated over the switches' respective ICs. As an alternative, the bottom of the enclosure's window 11 may instead be treated so as render the bottom of the window 11 more translucent. In this way, the bottom of the window 11 may alternatively be illuminated by a light projector from within the enclosure 28 that instead projects images of switch or function-identifying words, markings, or icons onto the window 11.

In summary, an instrumentation assembly or module pursuant to the present invention generally includes one or more proximity-sensing switches situated in various locations about its enclosure. For example, a switch may be situated within an enclosure and just behind the enclosure's thin window, or a switch may alternatively be situated just underneath a thin, outer skin layer of the dashboard. In this way, therefore, the switch can be activated without requiring mechanical penetration through the enclosure's window. As a result, dust and dirt is largely prevented from entering the enclosure and making it and its contents appear dirty and unattractive. Furthermore, though more conventional mechanical switches, such as pushbutton or rotary type switches, may also be included in an instrumentation assembly or module pursuant to the present invention, care should be exercised so that their inclusion does not inadvertently facilitate the introduction of dust and dirt into an instrumentation enclosure.

While the present invention has been described in what are presently considered to be its most practical and preferred embodiments or implementations, it is to be understood that the invention is not to be limited to the particular embodiments disclosed hereinabove. On the contrary, the present invention is intended to cover various modifications and equivalent arrangements included within the spirit and scope of the claims appended hereinbelow, which scope is to be accorded the broadest interpretation so as to encompass all such modifications and equivalent structures as are permitted under the law.

What is claimed is:

1. An instrumentation assembly for installation in a dashboard of a vehicle, said instrumentation assembly comprising:
an electronic controller having a memory for storing information;
an enclosure having a designated front section and a designated rear section, said front section including substantially transparent material so as to define a window;
a viewable gauge electrically connected to said controller and mounted within said enclosure so as to substantially face said window;
a viewable display electrically connected to said controller and mounted within said enclosure so as to substantially face said window; and
a proximity-sensing switch electrically connected to said controller and operable to sense the proximal presence of a mass;
wherein said display is operable to exhibit said information for viewing, and said switch is activatable by said mass to selectively control the exhibition of said information on said display.

2. An instrumentation assembly according to claim 1, wherein said information includes odometer total mileage information and trip mileage information for said vehicle.

3. An instrumentation assembly according to claim 1, wherein said rear section of said enclosure has a connector that is electrically connected to said controller and adapted for being electrically connected to an external wire harness.

4. An instrumentation assembly according to claim 1, wherein said gauge is an analog type gauge selected from the group consisting of a speedometer, a tachometer, a fuel-level gauge, and a coolant temperature gauge.

5. An instrumentation assembly according to claim 1, wherein said display is a digital type display selected from the group consisting of a light-emitting diode (LED) display, a liquid-crystal display (LCD), and a vacuum-fluorescent display (VFD).

6. An instrumentation assembly according to claim 1, wherein said proximity-sensing switch is a touch-sensor type switch selected from the group consisting of a field-effect switch, an electric-field switch, a capacitive switch, an infrared switch, an acoustic switch, and an electromagnetic switch.

7. An instrumentation assembly according to claim 1, wherein said switch is situated within said enclosure and just behind said window.

8. An instrumentation assembly according to claim 1, wherein said dashboard comprises and inner substrate and an outer skin, and said switch is situated just underneath said outer skin of said dashboard.

9. An instrumentation assembly according to claim 1, wherein said mass is an electrically conductive type mass selected from the group consisting of a human finger and a metallic stylus.

10. An instrumentation assembly according to claim 1, wherein:
said instrumentation assembly further comprises an indicator that is electrically connected to said controller and mounted within said enclosure so as to substantially face said window; and
said indicator is an illuminable type indicator selected from the group consisting of a left-turn indicator light, a right-turn indicator light, a high-beam indicator light, a battery-charge indicator light, an oil-pressure indicator light, a low-fuel indicator light, and a check-engine indicator light.

11. An instrumentation assembly according to claim 1, wherein:
said instrumentation assembly further comprises a light source that is electrically connected to said controller and mounted within said enclosure; and
said light source is operable to illuminate said gauge, said display, and said switch.

12. An instrumentation assembly for installation in a dashboard of a vehicle, said instrumentation assembly comprising:
an electronic controller having a memory for storing information;
an enclosure having a designated front section and a designated rear section, said front section including substantially transparent material so as to define a window;
at least one viewable gauge electrically connected to said controller and mounted within said enclosure so as to substantially face said window;
a viewable display electrically connected to said controller and mounted within said enclosure so as to substantially face said window;
at least one proximity-sensing field-effect switch electrically connected to said controller and operable to sense the proximal presence of a human finger; and
a light source electrically connected to said controller and mounted within said enclosure;
wherein said light source is operable to illuminate each said gauge, said display, and each said field-effect switch;
wherein said display is operable to exhibit said information for viewing; and
wherein each said field-effect switch is activatable by said human finger to selectively control the exhibition of said information on said display.

13. An instrumentation assembly according to claim 12, wherein at least one said field-effect switch is situated within said enclosure and just behind said window.

14. An instrumentation module for installation in a dashboard of a vehicle, said instrumentation module comprising:
an enclosure having a designated front section and a designated rear section, said front section including substantially transparent material so as to define a window, and said rear section having a connector adapted for being electrically connected to an external wire harness;
an electronic controller mounted within said enclosure, electrically connected to said connector, and having a memory for storing information;
at least one viewable gauge electrically connected to said controller and mounted within said enclosure so as to substantially face said window;
a viewable display electrically connected to said controller and mounted within said enclosure so as to substantially face said window;
at least one proximity-sensing field-effect switch electrically connected to said controller and situated both within said enclosure and just behind said window, each said field-effect switch being operable to sense the proximal presence of a human finger at said window; and
a light source electrically connected to said controller and mounted within said enclosure;
wherein said light source is operable to illuminate each said gauge, said display, and each said field-effect switch;
wherein said display is operable to exhibit said information for viewing; and
wherein each said field-effect switch is activatable by said human finger to selectively control the exhibition of said information on said display.

15. An instrumentation module according to claim 14, wherein:
said instrumentation module further comprises an audio system with speakers, said audio system is electrically connected to said controller, and said speakers are mounted at the periphery of said enclosure;
at least one said field-effect switch is activatable to selectively control operation of said audio system with speakers; and
said display is operable to exhibit volume control information for viewing.

16. An instrumentation module according to claim 15, wherein:
said instrumentation module further comprises an AM/FM radio tuner that is mounted within said enclosure and electrically connected to both said controller and said audio system;
said AM/FM radio tuner is adapted for being electrically connected to an external radio antenna via said connector;
at least one said field-effect switch is activatable to selectively control operation of said AM/FM radio tuner;
said display is operable to exhibit radio station tuning control information for viewing; and
said audio system with speakers is operable to play a radio station broadcast that is electrically communicated from said radio antenna via said connector.

17. An instrumentation module according to claim 15, wherein:
said controller is adapted for being electrically connected to an external compact disc (CD) player/changer via said connector;
at least one said field-effect switch is activatable to selectively control operation of said compact disc player/changer;
said display is operable to exhibit compact disc player/changer control information for viewing; and
said audio system with speakers is operable to play music that is electrically communicated from said compact disc player/changer via said connector.

18. An instrumentation module according to claim 15, wherein:
said controller is adapted for being electrically connected to an external phone system via said connector;
at least one said field-effect switch is activatable to selectively control operation of said phone system;
said display is operable to exhibit phone number information and also phone system control information for viewing; and
said audio system with speakers is operable to play a phone conversation that is electrically communicated from said phone system via said connector.

19. An instrumentation module according to claim 14, wherein:
said controller is adapted for being electrically connected to an external climate control system via said connector;
at least one said field-effect switch is activatable to selectively control operation of said climate control system; and
said display is operable to exhibit climate condition information and also climate control information for viewing.

20. An instrumentation module according to claim 14, wherein:
said controller is adapted for being electrically connected to an external navigation system via said connector;
at least one said field-effect switch is activatable to selectively control operation of said navigation system; and
said display is operable to exhibit navigation information and also navigation system control information for viewing.
